(19) United States
(12) Patent Application Publication
(10) Pub. No.: US 2013/0325696 A1
(43) Pub. Date: Dec. 5, 2013

(54) CALCULATING A MISCONDUCT PREDICTION VALUE

(71) Applicant: David Andrew Graves, Monte Sereno, CA (US)

(72) Inventor: David Andrew Graves, Monte Sereno, CA (US)

(21) Appl. No.: 13/484,895

(22) Filed: May 31, 2012

(51) Int. Cl. G06Q 20/38

(52) U.S. Cl. 705/39

(57) ABSTRACT

Examples disclosed herein relate to calculating a misconduct prediction value. Examples include calculating a misconduct prediction value for a remote computing service provider user account from payment data corresponding to a method of payment for consumption of resources of the service provider and utilization data quantifying consumption of a processing resource of the service provider by an application provided to the service provider in connection with the user account.

### BACKGROUND

A remote computing service provider may allow users to purchase remote computing services, such as Internet-based storage or processing services. Such remote computing services may be flexibly utilized by users to perform a variety of tasks for many different purposes. Many users will utilize the remote computing services for legitimate personal and business uses. Others, however, may utilize remote computing services for illegitimate purposes, such as carrying out Internet-based crime.

### BRIEF DESCRIPTION OF THE DRAWINGS

The following detailed description references the drawings, wherein:

FIG. 1 is a block diagram of an example computing device to calculate a misconduct prediction value for a remote computing service provider user account;

FIG. 2 is a block diagram of an example system including a misconduct prediction computing device to selectively output a misconduct prediction notice based on a calculated misconduct prediction value;

FIG. 3 is a flowchart of an example method for calculating a misconduct prediction value for a plurality of remote computing service provider user accounts; and

FIG. 4 is a flowchart of an example method for outputting a misconduct prediction report identifying a set of remote computing service provider user accounts.

### DETAILED DESCRIPTION

As noted above, some users of remote computing services may utilize those services for illegitimate purposes, such as carrying out Internet-based crime. For example, a malicious user wishing to conceal their identity may purchase remote computing services, such as cloud services, with which to perform Internet-based crime rather than doing so with their own computer. Such a user may rent processing resources, networking resources, and storage resources of a remote computing service provider to run an illegitimate application to, for example, launch denial-of-service attacks, serve as the command center of a malicious botnet, etc. To further conceal their identity, the malicious user may also use stolen payment information (e.g., stolen credit card information) to pay for the remote computing services.

A remote computing service provider may wish to detect and stop such illegitimate uses of its services. However, investigating each suspicious activity involving the remote computing services provided by the service provider is time-consuming and expensive. Moreover, many seemingly suspicious activities may not be associated with any illegitimate use of the services, and investigating such activities may waste valuable security resources.

To address these issues, examples described herein provide a tool to calculate a misconduct prediction value for a user account of a remote computing service provider from payment data and utilization data associated with the user account. In such examples, the payment data may correspond to a method of payment for consumption of resources of the remote computing service provider, and the utilization data may quantify consumption of at least one processing resource of the remote computing service provider by at least one application provided to the service provider in connection with the user account. Examples described herein may use the calculated misconduct prediction value to predict whether the user account merits investigation for illegitimate activity. For example, misconduct prediction values calculated for a plurality of user accounts may be used to determine which user accounts are most suspicious so that security resources may be focused on such user accounts.

Additionally, by calculating misconduct prediction values from both payment data and utilization data, examples described herein may identify a user account as high risk based on a combination of payment activities and resource utilization before either of those factors individually rises to a level that would merit investigation. Moreover, the combination of suspicious payment activity and suspicious resource usage associated with a user account may be more indicative of a malicious user than either suspicious payment activity or suspicious resource usage alone.

For example, a user account associated with both suspicious payment activity and suspicious resource utilization may be using stolen payment information to purchase services for illegitimate activities, while seemingly suspicious payment activity or resource usage alone may sometimes result from legitimate activities (e.g., unusual resource usage by a legitimate user application). As such, by calculating misconduct prediction values from both payment data and utilization data, examples described herein may better differentiate between user accounts using the services for illegitimate purposes and user accounts associated with legitimate but seemingly suspicious activities.

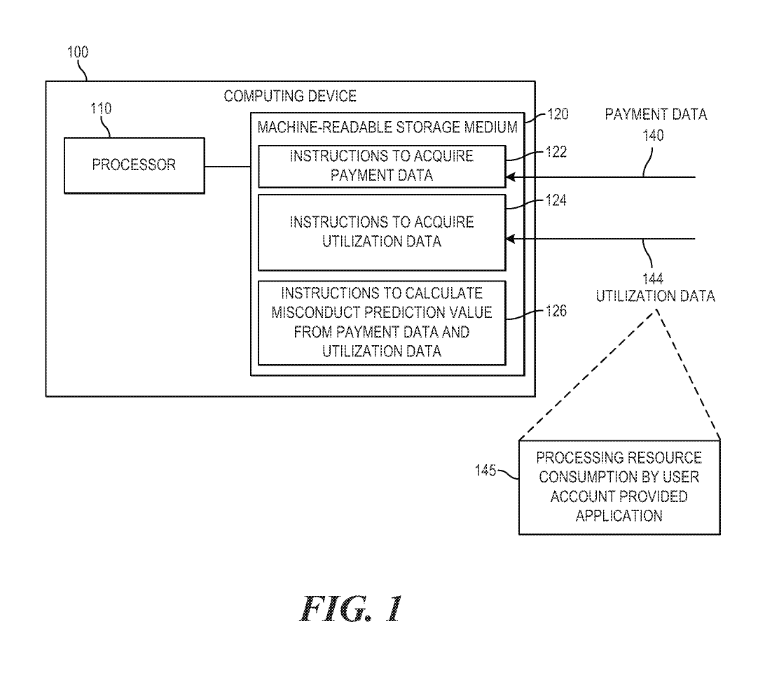

Referring now to the drawings, FIG. 1 is a block diagram of an example computing device 100 to calculate a misconduct prediction value for a remote computing service provider user account. As used herein, a “remote computing service provider” is an entity that sells, rents, or otherwise provides remote computing services such as remote processing services, remote networking services, remote storage services, and the like. In some examples, the remote computing service provider may be an Internet-based services provider that provides Internet-based processing services, Internet-based networking services, Internet-based storage services, and the like. For example, the remote computing service provider may be a cloud services provider that provides cloud resources such as cloud processing resources, cloud networking resources, cloud storage, or any other cloud resource.

In examples described herein, the remote computing services may be implemented by at least one of hardware and software (e.g., executable instructions encoded on a machine-readable storage medium) of at least one remote computing services data center. In some examples, the remote computing services provided by the data centers may be accessed via at least one computer network, the Internet, etc. In the example of FIG. 1, computing device 100 may be included as part of one of the data centers or may be separate from the data centers.

In some examples, users may utilize Internet-based services, cloud services, or other such remote computing services of the service provider to run at least one application (e.g., executable instructions) provided to the service provider by the user. For example, a user may upload an application to a data center of the service provider which may execute the provided application with at least one virtual machine executing at the data center, with at least one physical machine or other hardware of the data center, or a combination thereof. In such examples, the user-provided application, when executing, may consume a variety of remote computing service resources, such as processing resources, networking resources, storage resources, and the like, of the service provider.

Additionally, in examples described herein, a remote computing service provider may allow users to create user accounts through which the users may access remote computing services and pay for remote computing services consumed in connection with the user accounts. The service provider may track the consumption of remote computing resources in connection with each user account, and a user may provide payment information (e.g., credit card information) to pay for charges incurred in connection with the user account.

As noted above, in the example of FIG. 1, computing device 100 may calculate a misconduct prediction value for a remote computing service provider user account. As used herein, a “computing device” may be a desktop or notebook computer, server, tablet computer, mobile phone, smart device, or any other device or equipment including a processor. In the example of FIG. 1, computing device 100 includes a processor 110 and a machine-readable storage medium 120 encoded with instructions 122, 124, and 126. In some examples, storage medium 120 may include additional instructions. In other examples, instructions 122, 124, and 126, and any other instructions described herein in relation to storage medium 120, may be stored remotely from computing device 100.

As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. Processor 110 may fetch, decode, and execute instructions stored on storage medium 120 to implement the functionalities described below. In other examples, the functionalities of any of the instructions of storage medium 120 may be implemented in the form of electronic circuitry, in the form of executable instructions encoded on a machine-readable storage medium, or a combination thereof.

As used herein, a “machine-readable storage medium” may be any electronic, magnetic, optical, or other physical storage device to contain or store information such as executable instructions, data, and the like. For example, any machine-readable storage medium described herein may be any of Random Access Memory (RAM), flash memory, a storage drive (e.g., a hard disk), a Compact Disc Read Only Memory (CD-ROM), and the like, or a combination thereof. Further, any machine-readable storage medium described herein may be non-transitory.

In the example of FIG. 1, instructions 122 may actively or passively acquire (e.g., retrieve, receive, etc.) payment data 140. In some examples, instructions 122 may store the acquired payment data 140 in memory of computing device 100 or in memory remote from computing device 100, for example. As used herein, “payment data” is information corresponding to at least one method of payment provided to a remote computing service provider to pay for consumption of resources of the service provider by a user account of the service provider. Also, as used herein, a “method of payment” is information that a remote computing service provider may charge or otherwise use to acquire payment. Example methods of payment include credit card information, debit card information, bank account information, or any other type of financial information the service provider may charge or otherwise use to receive payment. In some examples, payment data 140 may include at least one of information regarding instances of a method of payment associated with a user account being changed, disputed transactions in connection with a method of payment associated with the user account, a refused transactions in connection with a method of payment associated with the user account, and the like.

In the example of FIG. 1, instructions 124 may actively or passively acquire utilization data 144. In some examples, instructions 124 may acquire utilization data 144 from a computing device (e.g., a server) of a data center of the service provider. In other examples, instructions 124 may acquire portions of utilization data 144 from each of a plurality of computing devices of a plurality of service provider data centers. In some examples, instructions 122 may acquire payment data 140 from at least one computing device of at least one service provider data center.

As used herein, “utilization data” is information regarding the usage of at least one remote computing service resource of a remote computing service provider in connection with a user account of the service provider. As used herein, remote computing service resources may include, for example, a processing resource, a networking resource, a storage resource, and the like, of a remote computing service provider. In some examples, a user may provide (e.g. upload) at least one application (e.g., piece of software or other executable instructions) to execute with at least one processing resource of the remote computing service provider, in such examples, each user-provided application may be provided in connection with the user account of the user providing the application. For example, a user may provide such applications to the service provider while logged into an interface provided by the service provider using credentials associated with the user account.

As used herein, a “processing resource” of a remote computing service provider is at least one processor of a data center of the service provider that a user may access via an electronic communications network to execute or otherwise perform processing tasks at the direction of at least one application provided to the service provider by the user. A processing resource of a remote computing service provider may be referred to herein as a “remote processing resource” or a “remote user-provided application processing resource”. As used herein, an electronic communications network may include at least one computer network, at least one telephone network, or a combination thereof. In some examples, suitable computer networks include, for example, a local area network (LAN), a wireless local area network (WLAN), a virtual private network (VPN), the Internet, and the like. In some examples, a processing resource may also be accessed by a user via an electronic communications network to perform processing tasks not in connection with a user-provided application. Additionally, in some examples, processing resources may be processing resources available to users over the Internet from an Internet-based services provider, a cloud services provider, or the like.

In some examples, utilization data 144 may include a level of consumption 145 of at least one processing resource of the remote computing service provider by at least one application provided to the service provider in connection with a user account. In other examples, utilization data 144 may otherwise quantify the consumption of processing resources by applications provided in connection with the user account. In some examples, the level of consumption 145 may include an amount of consumption of processing resources by the user-provided applications over a given period of time or over the life of the user account, for example. In some examples, utilization data 144 may include a level of consumption of processing resources in connection with the user account, including consumption by user-provided applications and consumption not in connection with any user-provided application.

In the example of FIG. 1, instructions 126 may calculate, with processor 110, a misconduct prediction value for a user account from acquired payment data 140 and acquired utilization data 144 associated with the user account. As used herein, a “misconduct prediction value” for a user account is information indicating an estimated level of suspicious use of at feast one remote computing service resource of the service provider in connection with the user account. In some examples, greater misconduct prediction values may indicate greater estimated levels of suspicious use. In other examples, lower misconduct prediction values may indicate greater estimated levels of suspicious use.

In some examples, instructions 126 may determine at least one payment risk value based on at least payment data 140, determine at least one utilization risk value based on at least utilization data 144, and derive the misconduct prediction value from at least each determined payment risk value and each determined utilization risk value. For example, instructions 126 may derive the misconduct prediction value by combining (e.g., adding, etc.) at least each of the determined payment values and the determined utilization risk values.

In some examples, instructions 126 may also utilize at least one correlation value, indicating a correlation between misconduct risks underlying the determined risk values, to derive the misconduct prediction value. For example, instructions 126 may derive the misconduct prediction value from the determined payment and utilization risk values and at least one correlation value by combining (e.g., adding) the risk and correlation values. Additionally, in some examples, instructions 126 may calculate a respective misconduct prediction value for each of a plurality of user accounts of the remote computing service provider. In such examples, instructions 122 may acquire payment data 140 for each of the plurality of user accounts, and instructions 124 may acquire utilization data 144 for each of the plurality of user accounts.

In the example of FIG. 1, instructions 126 may calculate a payment risk value based on a number of times that a method of payment associated with the user account has changed within a monitored time period, as indicated in the payment data 140. As noted above, to conceal their identity, a malicious user of remote computing services may use stolen payment information, such as stolen credit card information, to pay for the remote computing services. However, stolen payment information may have a short lifespan for the malicious user. For example, a stolen credit card may be cancelled relatively quickly after being stolen. As such, to continuously use stolen payment information, a malicious user may change the payment information associated with their account relatively frequently within a short time period as the stolen payment information ceases to work. Accordingly, while a small number payment method changes associated with a user account may not be indicative of a malicious user, a relatively high number of changes within a small period of time may be.

In some examples, instructions 126 may calculate the payment risk value based on payment method changes by multiplying the number of times a method of payment associated with the user account has changed within the monitored time period by given value. In such examples, the payment risk value may be greater the more times the payment method has been changed within the monitored time period. Additionally, the monitored time period may be any suitable time period, such as, for example, a number of days, weeks, month, etc. In other examples, instructions 126 may set the payment risk value to a low value (e.g., zero) if payment data 140 indicates that less than a threshold number of payment method changes for the user account have occurred within the monitored time period, and may set the payment risk value to a higher value if payment data 140 indicates that the number of payment method changes for the user account within the monitored time period meet or exceed the threshold number. In other examples, instructions 126 may calculate the payment risk value based on payment method changes in any other suitable manner based on the number of times that a payment method associated with the user account has changed within a monitored time period.

In some examples, instructions 126 may calculate another payment risk value based on each indication in payment data 140 of a disputed transaction in connection with a method of payment associated with the user account within the monitored time period. In some examples, disputed transactions in connection with a payment method, such as disputed charges on a credit card account, may indicate that the payment method information has been stolen, although the theft may not have been detected yet. In some examples, instructions 126 may calculate the disputed translation payment risk value based on at least one of the number of disputed transactions within the monitored time period indicated in payment data 140 and the amount of each disputed transaction. Payment data 140 may indicate disputed transactions for any payment method currently or previously associated with the user account.

In the example of FIG. 1, instructions 126 may calculate another payment risk value based on each indication in payment data 140 of a refused transaction in connection with a method of payment associated with the user account within the monitored time period. In some examples, refused transactions in connection with a payment method, such as refused attempts to use make a charge on a credit card account, may indicate that the payment method information has been stolen. In some examples, instructions 126 may calculate the refused transaction payment risk value based on at least one of the number of refused transactions within the monitored time period indicated in payment data 140 and the amount of each refused transaction. Payment data 140 may indicate refused transactions for any payment method currently or previously associated with the user account. In examples described herein, instructions 126 may determine any combination of the payment risk values described above.

As noted above, in some examples, computing device 100 may acquire payment data 140 and utilization data 144 from at least one computing device of a data center of the service provider. In such examples, the data center computing devices may receive information regarding disputed and refused transactions in connection with payment methods associated with user accounts from at least one third-party billing service separate from any of the service provider data centers. In some examples, instructions 126 may calculate at least one of the first, second, and third payment risk values as part of the calculation of the misconduct prediction value for a user account. In other examples, instructions 126 may additionally or alternatively determine other risk values based on payment data 140.

In the example of FIG. 1, utilization data 144 may further include at least one of a level of consumption of at least one networking resource by at least one application provided to the service provider in connection with the user account and a level of consumption of at least one storage resource of the remote computing service provider by the at least one application provided in connection with the user account. In other examples, utilization data 144 may otherwise quantify the consumption of networking resources and storage resources of the service provider by applications provided in connection with the user account. As used herein, a “networking resource” of a remote computing service provider is at least one computer networking device or other computer networking equipment of the service provider that a user may access via an electronic communications network to perform networking tasks at the direction of at least one application provided to the service provider by the user. A networking resource of a remote computing service provider may be referred to herein as a “remote networking resource”. Networking tasks that may be performed by a networking resource may include, for example, sending, receiving, or otherwise processing network traffic. In some examples, a networking resource may also be accessed by a user via an electronic communications network to perform networking tasks not in connection with a user-provided application. Additionally, in some examples, networking resources may be available to users over the Internet from an Internet-based services provider, a cloud services provider, or the like.

Additionally, as used herein, a “storage resource” of a remote computing service provider is any type of storage of the service provider that a user may access via an electronic communications network to store information such as executable instructions, data, and the like, in connection with or at the direction of at least one application provided to the service provider by the user. A storage resource of a remote computing service provider may be referred to herein as a “remote storage resource.” In some examples, a storage resource may be at least a portion of at least one physical storage device, such as a machine-readable storage medium, at least a portion of at least one virtual storage medium, or a combination thereof. A virtual storage medium may include, for example, a logical address space that may be mapped to at least one physical storage device of the service provider. In some examples, a storage resource may also be accessed by a user via an electronic communications network to perform storage tasks not in connection with a user-provided application. Additionally, in some examples, storage resources may be storage available to users over the Internet from an Internet-based services provider, a cloud services provider, or the like.

As noted above, in some examples, instructions 126 may also determine at least one utilization risk value based on utilization data 144, which instructions 126 may use in deriving a misconduct prediction value. For example, instructions 126 may calculate a utilization risk value based on a degree to which the respective levels of consumption of at least one processing resource, at least one networking resource, and at least one storage resource correspond to at least one misconduct utilization profile. In some examples, resource consumption levels for a user account corresponding to a misconduct utilization profile may indicate that remote computing services are being used for inappropriate purposes in connection with the user account. For example, a user account having very low consumption of processing resources, very low consumption of storage resources, and high consumption of networking resources may indicate that the user account is being used to launch a denial-of-service attack using remote computing resources of the service provider.

In some examples, instructions 126 may define at least one misconduct utilization profile. The misconduct utilization profiles may be defined by for example, respective consumption thresholds, ratios, or the like, for at least one of processing resources, networking resources, and storage resources of a remote computing service provider. In such examples, instructions 126 may calculate the misconduct profile utilization risk value for a user account by determining a degree to which the respective processing resource, networking resource, and storage resource consumption levels included in the utilization data 140 for the user account correspond to the thresholds, ratios, etc., defining the misconduct utilization profiles.

For example, a misconduct utilization profile may include a plurality of consumption thresholds, such as a processing resource consumption threshold, a networking resource consumption threshold, and a storage resource consumption threshold. In some examples, the consumption thresholds may be defined as a percentage of resource capacity. For example, a misconduct utilization profile may define the processing resource consumption threshold as a certain percentage of allocated processing resource processing capacity, which may vary across user accounts. In such examples, the other consumption thresholds may also be defined in terms of a percentage of allocated capacity. In such examples, instructions 126 may determine the degree to which the consumption levels included in the utilization data 144 match the defined thresholds. For example, instructions 126 may determine, for each threshold, a difference between the threshold and a corresponding consumption percentage for the user account, and combine (e.g., add) the differences to determine the degree to which the consumption levels correspond to the thresholds of the profile. In other examples, instructions 126 may use any other suitable manner of determining the degree to which the consumption levels for the user account correspond to a misconduct utilization profile. For example, instructions 126 may calculate a Pearson product-moment correlation coefficient to determine the degree to which the consumption levels correspond to the thresholds of a misconduct utilization profile.

Additionally, in some examples, the misconduct utilization profiles may also include information other than consumption levels as part of the profile definition, and the utilization data 144 may contain information for a user account to compare against other aspects of the profiles. For example, a denial-of-service attack may be directed at a small number of Internet Protocol (IP) addresses. As such, a misconduct utilization profile for detecting denial-of-service attacks may also include a threshold or other measure of the number of destination IP addresses to which traffic is sent in connection with a user account. In such examples, utilization data 144 may also include corresponding utilization information from which instructions 126 may determine a number of destination IP addresses to which traffic is sent in connection with a user account.

Additionally, in some examples, resource consumption levels for a user account that deviate from a standard utilization profile may indicate that remote computing services are being used for inappropriate purposes in connection with the user account. For example, a user account having relatively high consumption of processing, networking, and storage resources may be a typical consumption pattern associated with legitimate use. Similarly, relatively low consumption of each of processing, networking and storage resources may also be typical. Likewise, moderate usage of each of these resources may also be typical. As such, deviation from such standard utilization profiles may indicate that remote computing resources are being used for inappropriate purposes. Accordingly, in some examples, instructions 126 may calculate another utilization risk value based on a degree to which the respective levels of consumption of at least one processing resource, at least one networking resource, and at least one storage resource deviate from a standard utilization profile. In some examples, the standard utilization profiles may be defined as described above in relation to the misconduct utilization profiles. In such examples, instructions 126 may determine the degree to which the consumption levels associated with a user account deviate from a standard utilization profile using methods similar to those described above in relation to determining a degree of correlation with misconduct utilization profiles.

In the example of FIG. 1, instructions 126 may determine the payment and utilization risk values in a manner that attributes different weights to the different misconduct risks underlying the payment and utilization risk values. For example, instructions 126 may contribute twice as much to a payment risk value per disputed transaction than instructions 126 contribute per payment method change. In examples described herein, a misconduct risk may be any detected circumstance contributing to a payment risk value or utilization risk value. Misconduct risks may include, for example, changes in payment method, disputed transaction, and refused transactions, as described above, or any other circumstance detected for determining a payment or utilization risk value. In the example of FIG. 1, the misconduct risks may be detected by instructions 126, which may contribute to a payment or utilization risk value in response to detecting the misconduct risk.

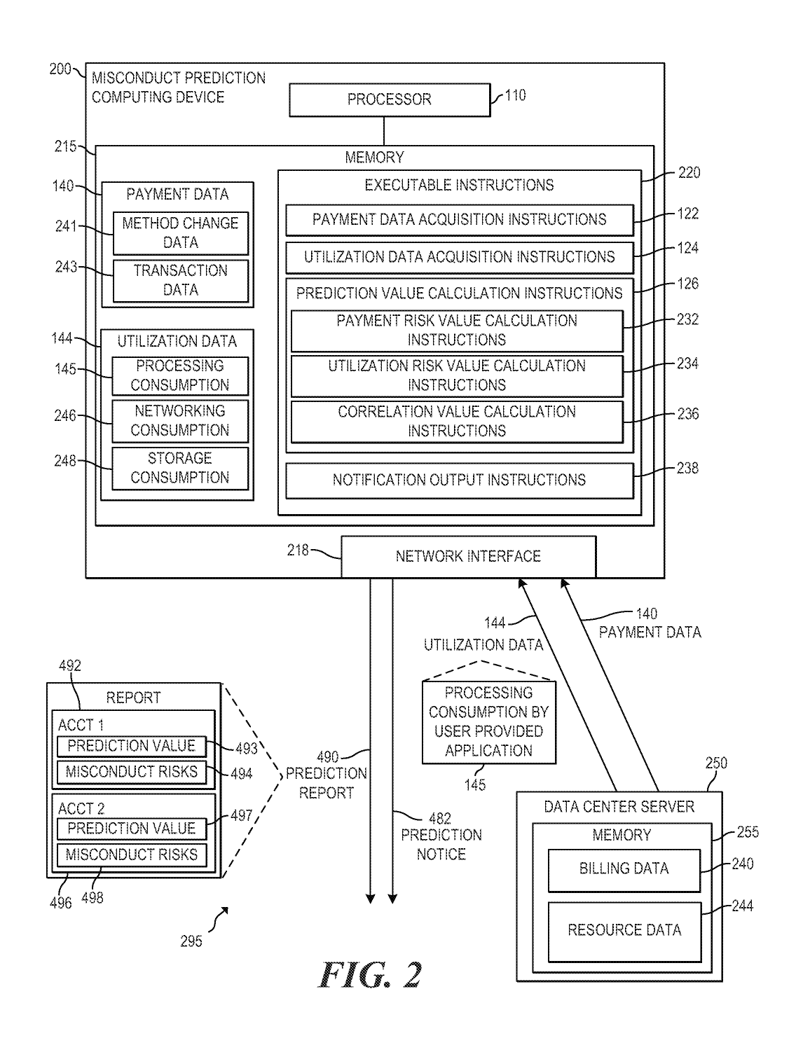

Additionally, in some examples, instructions 126 may also utilize at least one correlation value in deriving a misconduct prediction value, in addition to the payment and utilization risk values. In such examples, instructions 126 may determine a correlation value based on whether any misconduct risk underlying a determined payment risk value and any misconduct risk underlying a determined utilization risk value occurred within a given time period (e.g., a day, week, month, etc.) of each other. Additionally or alternatively, instructions 126 may determine a correlation value based on whether a particular misconduct risk (e.g., a disputed charge) underlying a determined payment risk value and a particular misconduct risk (e.g., correlation with a misconduct utilization profile) underlying a determined utilization risk value occurred within a given time period (e.g., a day, week, month, etc.) of each other. In some examples, functionalities described herein in relation to FIG. 1 may be provided in combination with functionalities described herein in relation to any of FIGS. 2-4.

FIG. 2 is a block diagram of an example system 295 including a misconduct prediction computing device 200 to selectively output a misconduct prediction notice based on a calculated misconduct prediction value. In the example of FIG. 2, misconduct prediction computing device 200 may include a processor 110, as described above in relation to FIG. 1. Computing device 200 may also include a memory 215, which may be a machine-readable storage medium. Memory 215 may be encoded with a set of executable instructions 220, including at least instructions 122, 124, and 126, as described above in relation to FIG. 1. Memory 215 may also include instructions 232, 234, 236, and 238. In other examples, executable instructions 220 may include additional instructions. In the example of FIG. 2, processor 110 may fetch, decode, and execute instructions stored on memory 215 to implement the functionalities described below. In other examples, the functionalities of any of the instructions stored on memory 215 may be implemented in the form of electronic circuitry, in the form of executable instructions encoded on a machine-readable storage medium, or a combination thereof.

In the example of FIG. 2, computing device 200 may also include a network interface 218. As used herein, a “network interface” is at least one hardware component that may be used by a computing device to communicate with at least one other computing device via a communications network including at least one computer network, at least one telephone network, or a combination thereof. In some examples, instructions 122 may acquire payment data 140, as described above in relation to FIG. 1, and may store payment data 140 in memory 215. Payment data 140 may correspond to at least one method of payment for consumption of resources of a remote computing service provider in connection with a user account of the service provider. For example, payment data 140 may be associated with at least one method of payment provided to a remote computing service provider to pay for consumption of resources of the service provider by a user account of the service provider. In the example of FIG. 2, payment data 140 may be the same as payment data 140 described above in relation to FIG. 1. In some examples, payment data 140 may include payment method change data 241 regarding instances of a method of payment associated with a user account being changed, and transaction data 243 regarding disputed and refused transactions in connection with a method of payment associated with the user account, and the like.

Instructions 124 may acquire utilization data 144, as described above in relation to FIG. 1. Utilization data 144 may indicate consumption of at least one processing resource of the remote computing service provider by at least one application provided to the service provider in connection with the user account. For example, utilization data 144 may include a level of consumption 145 of at least one processing resource of the remote computing service provider by at least one application provided to the service provider in connection with a user account. In some examples, instructions 124 may store acquired utilization data 144 in memory 215. In the example of FIG. 2, utilization data 144 may be the same as utilization data 144 described above in relation to FIG. 1. In some examples, utilization data 144 may include the level of consumption 145 of at least one processing resource, and may also include a level of consumption 246 of at least one networking resource and a level of consumption 248 of at least one storage resource. In some examples, utilization data 144 may otherwise quantify the consumption of processing, networking, and storage resources of the service provider by applications provided in connection with the user account. In the example of FIG. 2, executable instructions 220, payment data 140, and utilization data may be stored in the same memory 215, or may be stored in separate machine-readable storage mediums.

In the example of FIG. 2, instructions 122 and 124 may acquire, with network interface 218, payment data 140 and utilization data 144 from a data center server 250. In such examples, data center server 250 may be a server of a data center of a remote computing service provider, and may include a memory 255, which may be at least one machine-readable storage medium. In some examples, memory 255 may store billing data 240 and resource data 244. Billing data 240 may include information regarding billing events and payment methods associated with user accounts, such as payment method change data, disputed and refused transaction data, as well as information regarding successful transactions for a plurality of user accounts. For example, billing data 240 may be the source data from which payment data 140 is collected. Resource data 244 may include information regarding the utilization and configuration of remote computing resources of the service provider, such as remote processing, networking, and storage resources, associated with each of a plurality of user accounts. For example, resource data 244 may be the source data from which utilization data 144 is collected. In such examples, instructions 122 may retrieve, with network interface 218, payment data 140 from among billing data 240, and instructions 124 may retrieve, with network interface 218, utilization data 144 from among resource data 244.

In some examples, at least one of billing data 240 and resource data 244 may be stored in a distributed manner among a plurality of logs stored at server 250. In other examples, at least some of the logs may be stored remotely from server 250, such as at another location within the same data center, or at another data center of the service provider. In such examples, instructions 122 may acquire, via network interface 218, payment data 140 from among the logs storing billing data 240, and instructions 124 may acquire, via network interface 218, utilization data 144 from among the logs storing resource data 244.

Instructions 126 may calculate, with processor 110 from payment data 140 and utilization data 144, a misconduct prediction value indicating a level of suspicious use of at least one resource of the service provider in connection with a user account, as described above in relation to FIG. 1. In the example of FIG. 2, instructions 126 include instructions 232, 234, and 236. In such examples, instructions 232 may determine at least one payment risk value for a user account based on at least the received payment data 140. Instructions 234 may determine at least one utilization risk value for the user account based on at least the received utilization data 144. In some examples, instructions 232 and 234 may calculate payment and utilization risk values such that at least one determined payment risk value is different than at least one determined consumption risk value. For example, such risk values may be determined to attribute different weights to different misconduct risks underlying the risk values, as described above in relation to FIG. 1. Additionally, instructions 236 may determine at least one correlation value based on the payment data 140 and the utilization data 144, as described above in relation to FIG. 1.

In the example of FIG. 2, instructions 126 may derive the misconduct prediction value from at least each determined payment risk value and each determined consumption risk value, as described above in relation to FIG. 1. In some examples, instructions 126 may derive the misconduct prediction value from at least each determined payment risk value, each determined utilization risk value, and each determined correlation value.

In the example of FIG. 2, instructions 232 may determine any of the payment risk values described above in relation to FIG. 1. In such examples, instructions 232 may determine those payment risk values as described above in relation to FIG. 1. In some examples, instructions 232 may also determine other payment risk values based on other underlying misconduct risks. In the example of FIG. 2, instructions 234 may determine any of the utilization risk values described above in relation to FIG. 1. In such examples, instructions 232 may determine those utilization risk values as described above in relation to FIG. 1.

Instructions 234 may also calculate another utilization risk value based on a degree to which network port information associated with the user account corresponds to a misconduct port profile. The network port information may be included in the acquired utilization data 144. As used herein, “network port information” associated with a user account is information indicating network ports that are open in connection with a user account. For example, a user may request that at least one network port be opened in connection with their user account for use by at least one of processing resources, networking resources, and storage resources consumed in association with the user account. In such examples, at least one application provided to the service provider in connection with the user account may utilize remote computing resources of the service provider to send and receive network traffic via the open network ports. In examples described herein, network ports may be identified by network port numbers, or other identifiers.

In some examples, certain network ports may be associated with malicious activities. For example, particular network ports may be used by known malicious applications (e.g., malicious toolkits, etc.). As such, certain network ports being open in connection with a user account may indicate that remote computing services are being used for inappropriate purposes in connection with the user account. Accordingly, in some examples, instructions 234 may calculate a utilization risk value based on a degree to which network port information associated with the user account corresponds to a misconduct port profile.

In some examples, instructions 234 may include the malicious port profile, which may be a list (e.g., a table, etc.) of suspicious network ports. In some examples, instructions 234 may calculate the third utilization risk value based on the number of network ports open in connection with a user account are included in the list of suspicious network ports. In other examples, the list may include a particular risk value associated with each of the suspicious network ports. In this manner, different weights may be given to the suspicious ports in some examples. In such examples, instructions 234 may calculate the utilization risk value by adding together the risk values associated with each of the suspicious network ports open in connection with the user account, as indicated in the network port information for the user account.

Additionally, certain network ports are commonly used for legitimate purposes. For example, network port “80” is commonly used in connection with the hypertext transfer protocol (HTTP), network port “22” is commonly used in connection with the secure shell (SSH) protocol, etc. In some examples, a determination that none of a plurality of commonly used ports is open in connection with a user account may indicate that remote computing services are being used for inappropriate purposes in connection with the user account. Accordingly, in some examples, instructions 234 may calculate another utilization risk value based on whether the network port information included in utilization data 144 deviates from a standard port profile. In some examples, instructions 234 may include the standard port profile, which may be a list of network ports commonly used for legitimate purposes. In some examples, instructions 234 may calculate a non-zero value for the fourth utilization risk value if none of the network ports included in the standard port profile is open in connection with a user account.

By calculating a misconduct prediction value based on network port information and payment data 140, examples described herein may identify suspicious user accounts prior to any malicious activities being carried out. For example, if a malicious user attempts to use stolen payment information to pay for remote computing services, and then opens suspicious ports to be used for malicious activities, examples described herein may calculate a relatively high misconduct prediction value based on the payment data and the network port information before any malicious activities have been carried out.

In addition, certain geographical regions may be considered high-risk due to various factors, such as relatively weak Internet crime legislation in the region, high incidence of Internet crime involving the region, etc. As such, user input received in connection with the user account from one of these regions may elevate the risk that the user account may be used for illegitimate purposes. As such, examples described herein may determine another utilization risk value based on a source Internet Protocol (IP) address from which a server of the remote computing service provider receives input associated with the user account, if the source IP address corresponds to any one of a plurality of high-risk geographical regions. In some examples, a source IP address of user input may be included in the acquired utilization data 144.

In some examples, instructions 234 may include a high-risk region profile, which may be a list (e.g., a table, etc.) of high-risk geographical regions. In some examples, instructions 234 may determine a source IP address utilization risk value if a source IP address of user input associated with a user account corresponds to any one of the geographical regions included in the profile. In some examples, the list may include a particular risk value associated with each of the high-risk geographical regions. In this manner, different weights may be given to different regions in some examples. In such examples, instructions 234 may determine the source IP address utilization risk value to be the risk value listed in the profile for the geographical region associated with the source IP address of the user input.

Additionally, a user account sending network traffic primarily or exclusively to high-risk regions may also elevate the risk that the user account may be used for illegitimate purposes. As such, instructions 234 may determine another utilization risk value (e.g., a destination IP address utilization risk value) if destination IP addresses utilized in connection with a user account correspond to high-risk geographical regions. In some examples, the destination IP addresses utilized in connection with a user account may be included in utilization data 144.

In the example of FIG. 2, instructions 234 may determine the destination IP address utilization risk value if all or at least a relatively high proportion of the destination IP addresses utilized in connection with the user account correspond to high-risk geographical regions included in the high-risk region profile. In some examples, the list may include a particular risk value associated with each of the high-risk geographical regions. In this manner, different weights may be given to different regions in some examples. In such examples, instructions 234 may determine the destination IP address utilization risk value to be the risk value listed in the profile for the geographical region associated with the destination IP addresses, or a combination of the listed risk values if the destination IP addresses indicate more than one high-risk region. In examples described herein, instructions 234 may determine any combination of the utilization risk values described above in relation to instructions 234 and the utilization risk values described above in relation to FIG. 1.

Additionally, in the example of FIG. 2, instructions 238 may selectively output a misconduct prediction notice 482 identifying the user account based on the misconduct predication value. For example, instructions 238 may compare each misconduct prediction value calculated in connection with a user account to a misconduct threshold. The misconduct threshold may be set such that misconduct prediction values above the threshold indicate particularly suspicious user accounts in examples in which greater misconduct prediction values indicate greater estimated levels of suspicious use. In such examples, if instructions 238 determine that a misconduct prediction value calculated for a user account is above the misconduct threshold, then instructions 238 may output a prediction notice 482 indicating that the misconduct prediction value indicates that the user account is particularly suspicious. For example, prediction notice 482 may include the calculated misconduct prediction value. Instructions 238 may output the prediction notice 482 with a network interface 218. In some examples, instructions 238 may provide the prediction notice 482 to information security personnel for the remote computing service provider. In such examples, instructions 238 may alert security personnel of a particularly suspicious user account relatively quickly after calculating a high misconduct prediction value.

In some examples, instructions may calculate a misconduct prediction value, as described above in relation to FIGS. 1 and 2, for each of a plurality user accounts of the remote computing service provider. In such examples, instructions 238 may generate and output a misconduct prediction report 490 identifying the user accounts having the misconduct prediction values indicating the greatest levels of suspicious use among the plurality of user accounts. For example, after instructions 126 calculate the plurality of misconduct prediction values, instructions 238 may sort the misconduct prediction values and determine which user accounts are to be identified in report 490. Instructions 238 may identify, in report 490, a first set of the plurality of user accounts having misconduct prediction values indicating greater levels of suspicious use than user accounts in a second set of the plurality of user accounts. The user accounts may be identified in report 490 by including a suitable account identifier for each of the user accounts being identified.

For example, instructions 238 may compare the misconduct prediction values to a misconduct threshold. In such examples, instructions 238 may identify in report 490 each user account having a misconduct prediction value greater than the threshold, in examples in which greater misconduct prediction values indicate greater estimated levels of suspicious use. In other examples, instructions 238 may identify in report 490 some proportion of the user accounts having the greatest level of suspicious use based on the misconduct prediction values. For example, instructions 238 may identify in report 490 the user accounts having the top two percent (or another suitable percentage) of the calculated misconduct prediction values, in examples in which greater misconduct prediction values indicate greater levels of suspicious use.

In the example of FIG. 2, instructions 238 may output report 490 with network interface 218. In some examples, report 490 may be used by information security personnel to investigate the identified user accounts. As noted above, report 490 may include an account identifier for each user account being identified in report 490. In the example of FIG. 2, report 490 may also include other information that may be useful to security personnel utilizing the report. For example, report 490 may also include, for each of the identified user accounts, at least one of the respective misconduct prediction values identified for the user account and the determined misconduct risks underlying the misconduct prediction value, such as a payment method change frequency, correlation with a misconduct utilization profile, etc.

For example, as shown in FIG. 2, prediction report 490 may identify at least a first and a second user account. In such examples, report 490 may include first user account information 492 including a suitable account identifier, a misconduct prediction value 493 calculated for the first user account, and misconduct risk information 494, identifying misconduct risks underlying the misconduct prediction value 493. Similarly, report 490 may include second user account information 496 including a suitable account identifier, a misconduct prediction value 497 calculated for the second user account, and misconduct risk information 498, identifying misconduct risks underlying the misconduct prediction value 497. In other examples, report 490 may similarly identify additional user accounts. In some examples, functionalities described herein in relation to FIG. 2 may be provided in combination with functionalities described herein in relation to any of FIGS. 1 and 3-4.

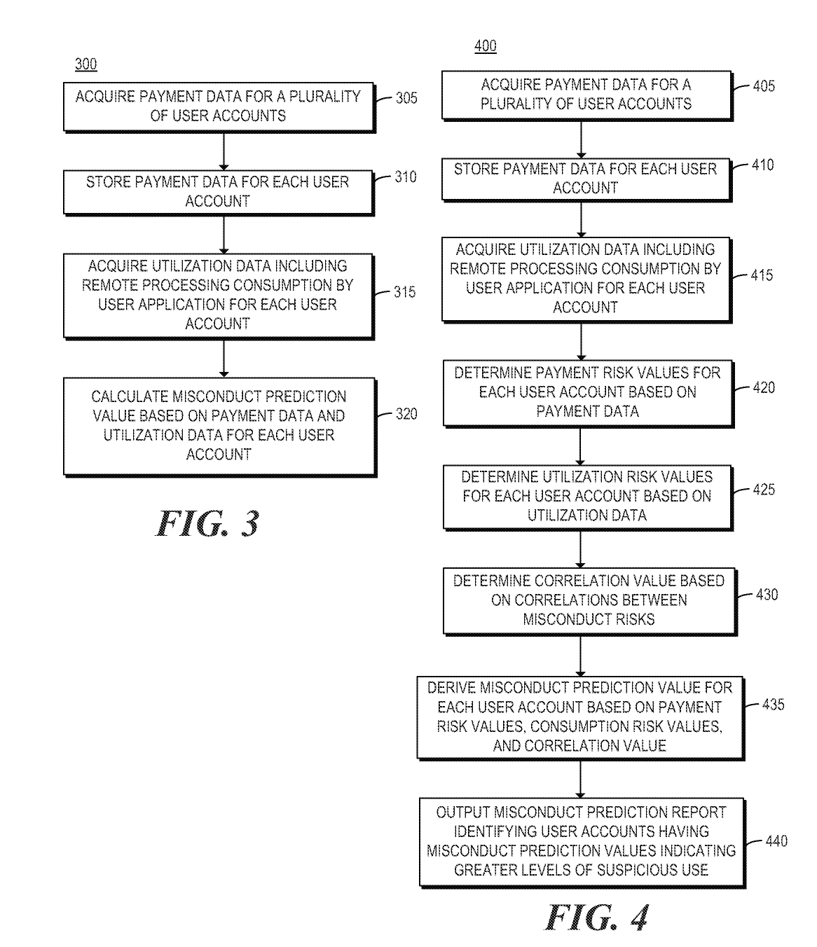

FIG. 3 is a flowchart of an example method 300 for calculating a misconduct prediction value for a plurality of remote computing service provider user accounts. Although execution of method 300 is described below with reference to computing device 200 of FIG. 2, other suitable components for execution of method 300 can be utilized (e.g., computing device 100). Additionally, method 300 may be implemented in the form of executable instructions encoded on a machine-readable storage medium, in the form of electronic circuitry, or a combination thereof.

At 305 of method 300, computing device 200 may acquire payment data 140 for each of a plurality of user accounts of a remote computing service provider. Computing device 200 may acquire payment data 140 with network interface 218, and may acquire payment data 140 from at least one data center server 250 of the remote computing service provider, such as at least one server of at least one data center of the remote computing service provider. In some examples, for each user account, the payment data 140 may be information associated with at least one method of payment provided to the service provider to pay for consumption of resources of the service provider by the user account.

At 310, computing device 200 may store the acquired payment data 140, for each of the user accounts, in memory 215 of computing device 200. At 315, computing device 200 may acquire, with network interface 218 utilization data 144 for each of the user accounts from at least one data center server 250 of the remote computing service provider. In some examples, utilization data 144 may quantify, for each of the user accounts, consumption of at least one processing resource, at least one networking resource, and at least one storage resource of the remote computing service provider by at least one application provided to the service provider in connection with the user account.

At 320, computing device 200 may calculate with a processor 110 of computing device 200 a misconduct prediction value for each of the user accounts from the acquired payment data 140 and the acquired utilization data 144 for the user accounts. Each of the misconduct prediction values may indicate a level of suspicious use of at least one resource of the service provider in connection with one of the user accounts. For each of the user accounts, the misconduct prediction value may be calculated from the payment data 140 associated with the user account and the utilization data 144 associated with the user account, as described above in relation to FIGS. 1 and 2.

FIG. 4 is a flowchart of an example method 400 for outputting a misconduct prediction report identifying a set of remote computing service provider user accounts. Although execution of method 400 is described below with reference to computing device 200 of FIG. 2, other suitable components for execution of method 400 can be utilized (e.g., computing device 100). Additionally, method 400 may be implemented in the form of executable instructions encoded on a machine-readable storage medium, in the form of electronic circuitry, or a combination thereof.

At 405 of method 400, computing device 200 may acquire payment data 140 for each of a plurality of user accounts of a remote computing service provider. Computing device 200 may acquire payment data 140 with network interface 218, and may acquire payment data 140 from at least one data center server 250 of the remote computing service provider, such as at least one server of at least one data center of the remote computing service provider. In some examples, for each user account, the payment data 140 may be information associated with at least one method of payment provided to the service provider to pay for consumption of resources of the service provider by the user account.

At 410, computing device 200 may store the acquired payment data 140, for each of the user accounts, in memory 215 of computing device 200. At 415, computing device 200 may acquire, with network interface 218 utilization data 144 for each of the user accounts from at least one data center server 250 of the remote computing service provider. In some examples, utilization data 144 may quantify, for each of the user accounts, consumption of at least one processing resource, at least one networking resource, and at least one storage resource of the remote computing service provider by at least one application provided to the service provider in connection with the user account.

At 420, computing device 200 may determine, for each of the user accounts, a plurality of payment risk values based on the acquired payment data 140 associated with the user account. Computing device 200 may determine any combination of the payment risk values described above in relation to FIG. 1. In such examples, computing device 200 may determine those payment risk values as described above in relation to FIGS. 1 and 2. At 425, computing device 200 may determine, for each of the user accounts, a plurality of utilization risk values based on the acquired utilization data 144 associated with the user account. Computing device 200 may determine any combination of the utilization risk values described above in relation to FIG. 1 or 2. In such examples, computing device 200 may determine the utilization risk values as described above in relation to FIGS. 1 and 2.

At 430, computing device 200 may determine, for each of the user accounts, at least one correlation value based on at least one correlation between misconduct risks underlying payment and utilization risk values determined for the user account. In some examples, computing device 200 may determine the correlation values for each user account as described above in relation to FIGS. 1 and 2. At 435, computing device 200 may derive, for each user account, a misconduct prediction value based on each determined payment risk value, consumption risk value, and correlation value for the user account. In such examples, the misconduct prediction values for each user account may be derived as described above in relation to FIGS. 1 and 2.

At 440, computing device 200 may output a misconduct prediction report 490 identifying a first set of the user accounts including user accounts having misconduct prediction values indicating greater levels of suspicious use than user accounts in a second set of the user accounts. In some examples, computing device 200 may determine the first set of the plurality of user accounts as described above in relation to FIG. 2. In some examples, the report 490 may further identify, for each of the user account identified in report 490 (i.e., for each of the user accounts of the first set), misconduct risks underlying the determined payment and utilization risk values for the user account.

1. A non-transitory machine-readable storage medium encoded with instructions executable by a processor of computing device, the storage medium comprising instructions to:
acquire payment data corresponding to a method of payment for consumption of a plurality of resources of a remote computing service provider in connection with a user account of the remote computing service provider;
determine a degree to which resource consumption values of a misconduct utilization profile correspond to respective levels of consumption of the plurality of resources of the remote computing service provider by an application provided to the remote computing service provider in connection with the user account; and
calculate a misconduct prediction value for the user account based on the acquired payment data and the determined degree to which the resource consumption values of the misconduct utilization profile correspond to the respective levels of consumption.

2. The storage medium of claim 1, wherein the instructions to calculate comprise instructions to:
determine at least one payment risk value based on the acquired payment data;
determine at least one utilization risk value based on acquired utilization data including the respective levels of consumption; and
derive the misconduct prediction value based on each determined payment risk value and each determined utilization risk value.

3. The storage medium of claim 2, wherein the instructions to determine the at least one payment risk value comprise instructions to:
calculate a first payment risk value based on a number of times that the method of payment associated with the user account has changed within a monitored time period, as indicated in the payment data.

4. The storage medium of claim 3, wherein the instructions to determine the at least one payment risk value further comprise instructions to:
calculate a second payment risk value based on each indication in the payment data of a disputed transaction in connection with a method of payment associated with the user account within the monitored time period; and
calculate a third payment risk value based on each indication in the payment data of a refused transaction in connection with a payment method of payment associated with the user account within the monitored time period.

5. The storage medium of claim 2, wherein the respective levels of consumption of the plurality of resources include at least one of a level of consumption of a processing resource, a level of consumption of a networking resource, and a level of consumption of a storage resource, each of the remote computing service provider and by the application provided to the service provider in connection with the user account.

6. The storage medium of claim 5, wherein the instructions determine the at least one utilization risk value comprise instructions to:
determine a degree to which the resource consumption values of the misconduct utilization profile correspond to the respective levels of consumption of the processing, networking, and storage resources of the remote computing service provider by the application provided to the remote computing service provider in connection with the user account; and
calculate a first utilization risk value based on the determined degree to which the resource consumption values correspond to the respective levels of consumption.

7. The storage medium of claim 6, wherein:
the respective levels of consumption indicate respective levels of consumption of a plurality of processing resources, a plurality of networking resources, and a plurality of storage resources, each of the remote computing service provider, by a plurality of applications provided to the service provider in connection with the user account; and
the instructions to determine the utilization risk value further comprise instructions to calculate a second utilization risk value based on a degree to which the respective levels of consumption of the processing resources, the networking resources, and the storage resources deviate from resource consumption values of a standard utilization profile.

8. A system comprising:
a memory encoded with a set of executable instructions; and
a processor to execute the instructions, wherein the instructions, when executed, cause the processor to:
determine a payment risk value based on payment data corresponding to a method of payment for consumption of processing, networking, and storage resources of a remote computing service provider in connection with a user account of the remote computing service provider;
determine a degree of correspondence between resource consumption values of a misconduct utilization profile and respective levels of consumption of the processing, networking, and storage resources of the remote computing service provider by an application provided to the remote computing service provider in connection with the user account; and
calculate a misconduct prediction value for the user account based on the payment risk value and the determined degree of correspondence.

9. The system of claim 8, wherein the instructions that cause the processor to calculate the misconduct value comprise instructions that, when executed, cause the processor to:
determine a plurality of payment risk values based on the acquired payment data;
determine a plurality of utilization risk values based on the acquired utilization data; and
derive the misconduct prediction value based on each determined payment risk value and each determined utilization risk value, wherein one of the determined payment risk values is different than one of the determined utilization risk values.

10. The system of claim 9, wherein the instructions that cause the processor to determine the utilization risk values comprise instructions that, when executed, cause the processor to:
determine a first number of network ports open in connection with the user account that are included in a list of suspicious network ports; and
calculate a first utilization risk value based on the first number;
calculate a non-zero second utilization risk value in response to a determination that no port included in a standard port profile is open in connection with the user account.

11. The of claim 10, wherein the instructions that cause the processor to determine the utilization risk values comprise instructions that, when executed, further cause the processor to:
determine a third utilization risk value based on a source Internet Protocol (IP) address from which a server of the remote computing service provider receives input associated with the user account, in response to a determination that the source IP address corresponds to any one of a plurality of high-risk geographical regions.

12. The system of claim 11, wherein the instructions that cause the processor to determine the utilization risk values comprise instructions that, when executed, further cause the processor to:
determine a fourth utilization risk value based on destination IP addresses utilized in connection with the user account, in response to a determination that at least one of the destination IP addresses corresponds to a to high-risk geographical regions.

13. A method comprising:
determining, with a processor of a computing device, a payment risk value based on payment data corresponding to a method of payment for consumption of processing, networking, and storage resources of a remote computing service provider in connection with the user account;
determining, with the processor, a first degree to which first resource consumption values of a misconduct utilization profile correspond to respective levels of consumption of the processing, a networking, and storage resources of the remote computing service provider by an application provided to the remote computing service provider in connection with the user account;
determining a second degree to which the respective levels of consumption of the processing, networking, and storage resources deviate from second resource consumption values of a standard utilization profile; and
combining the payment risk value, a first utilization risk value representing the determined first degree, and a second utilization risk value representing the determined second degree, to determine a misconduct prediction value for the user account.

14. The method of claim 13, farther comprising:
determining a correlation value based on a correlation between misconduct risks underlying determined payment and utilization risk values;
wherein the combining comprises combining the correlation value with the payment and utilization risk values to determine the misconduct prediction value.

15. The method of claim 14, further comprising:
outputting a misconduct prediction report identifying a first set of the user accounts including user accounts having greater misconduct prediction values, respectively, than user accounts in a second set of the user accounts, the report further identifying misconduct risks underlying determined payment and utilization risk values for the user accounts of the first set.

16. The method of claim 13, further comprising:
determining a first number of network ports open in connection with the user account that are included in a list of suspicious network ports; and
determining a second number of network ports open in connection with the user account that are included in a standard port profile; and
calculating third and fourth utilization risk values based on the first and second numbers, respectively;
wherein the combining comprises combining the payment risk value and each of the calculated utilization risk values to determine the misconduct prediction value for the user account.

17. The method of claim 13,
identifying network ports open in connection with the user account that are included in a list of suspicious network ports; and
adding together respective risk values associated with the identified network ports to calculate a third utilization risk value;
wherein the combining comprises combining the payment risk value and each of the calculated utilization risk values to determine the misconduct prediction value for the user account.

18. The storage medium of claim 2, wherein the instructions to determine the at least one utilization risk value comprise instructions to:
calculate a first utilization risk value based on the determined degree;
determine a first number of network ports open in connection with the user account that are included in a list of suspicious network ports; and
calculate a second utilization risk value based on the determined first number.

19. The storage medium of claim 18, wherein the instructions to determine the at least one utilization risk value farther comprise instructions to:
determine a second number of network ports open in connection with the user account that are included in a standard port profile; and
calculate a third utilization risk value based on the determined second number;
wherein the instructions to calculate comprise instructions to combine each determined payment risk value with at least the first, second, and third utilization risk values.

20. The system of claim 8, wherein the instructions, when executed, further cause the processor to:
selectively output a misconduct prediction notice identifying the user account based on the misconduct predication value.
